(19) United States
(12) Patent Application Publication
(10) Pub. No.: US 2014/0254184 A1
(43) Pub. Date: Sep. 11, 2014

(54) SET OF BICYCLE LAMPS FOR DETACHABLE MOUNTING ON A TUBULAR STRUCTURE

(71) Applicant: Z & M LTD., Valletta VLT (MT)

(72) Inventor: Lars Beck, Copenhagen (DK)

(73) Assignee: Z & M LTD., Valletta VLT (MT)

(21) Appl. No.: 14/349,524

(22) PCT Filed: Oct. 5, 2012
(86) PCT No.: PCT/IB2012/055380

§ 371 Date: Apr. 3, 2014

(30) Foreign Application Priority Data
Oct. 7, 2011 (DK) PA 2011 00777

(51) Int. Cl. B62J 6/02; B62J 6/04

(52) U.S. Cl. CPC B62J 6/02; B62J 6/04
USPC 362/476

(57) ABSTRACT

The invention pertains to a set of bicycle lamps for detachable mounting on a tubular structure of a bicycle, said set of lamps comprising a front lamp and a rear lamp, each of said lamps comprising: a substantially cylindrical light emitting element for emitting visible light of a specific wave length or a specific wave length range, a housing attached to said light emitting element, said housing comprising a power supply for supplying electrical energy to the light emitting element, the housing having a component with dimensions resembling the dimensions of a segment of said tubular structure and said substantially cylindrical light emitting element, said two lamps of said set of lamps being adapted to be connected to one another to form a body having a substantially elliptical cross section with one of the focal points of the ellipse being within the one of said cylindrical light emitting elements and the other focal point of the ellipse within the other of said cylindrical light emitting elements

### TECHNICAL FIELD

The present invention pertains to a set of bicycle lamps

### BACKGROUND OF THE INVENTION

The present invention relates to a set of lamps for detachable mounting on a tubular structure of a bicycle, which tubular structure may constitute e g. the frame of a bicycle.

Numerous bicycle lamp structures are known within the art such as from numerous patent specifications and design registrations. Examples of patent specifications in which bicycle lamps are described are published international patent application, publication No. WO91/00210, U.S. Pat. No. 5,197,795 and published British patent application, publication No 2,202,098.

Bicycle lamps to be detachably mounted on a supporting structure such as the frame or a part of the frame of a bicycle generally suffer from certain drawbacks since on the one hand the lamps have to be mounted on the frame of the bicycle by means of a separated holder device such as a receptor for receiving the bicycle lamp, and since, on the other hand, the lamps are very bulky and hard to store and carry along e.g. in a pocket or a suitcase. A further disadvantage relating to the prior art bicycle lamps relates to the sharp edged and bulky structure of the prior art bicycle lamps which may in some instances cause damage to e g a pocket in which the bicycle lamp is stored.

In order to overcome these drawbacks applicant's own patent European patent EP 0 672 578 suggests the provision of a set of bicycle lamps configured for detachable mounting on a tubular structure of a bicycle, wherein the lamps can be connected to each other in order to form a combined body having a generally smooth, convex surface, when they are not used.

Although it has been suggested to provide a lamp which alleviates the need of employing separated holder elements or fixating means serving the purpose of mounting and fixating the lamp relative to the frame of a bicycle, the prior art fails to teach a set of bicycle lamps, which may be mounted on a frame of a bicycle without the provision of separate fixating means, and which at the same time are so small that they can be comfortably stored in a normal average pocket and which simultaneously fulfills the legal standards regarding the strength and visibility of the light emitted from them.

### SUMMARY OF THE INVENTION

It is thus an object of the present invention to provide a set of bicycle lamps for detachable mounting on a tubular structure of a bicycle, such as the frame of a bicycle, which lamps is adapted to be detachably mounted on the tubular structure in question without the necessity of employing separated holder elements or fixating means serving the purpose of mounting and fixating the lamps relative to the supporting structure, and which lamps may further be stored in an extremely compact manner without presenting outer sharp corners or edges which might cause damage to e g a pocked in which the lamps is stored. It is a further object of the present invention to provide a lamp, which at the same time fulfills the legal requirements for the visibility of bicycle lights.

According to the present invention, the above-mentioned and other objects are fulfilled by a set of bicycle lamps for detachable mounting on a tubular structure of a bicycle, said set of lamps comprising a front lamp and a rear lamp, each of said lamps comprising:

a substantially cylindrical light emitting element for emitting visible light of a specific wave length or a specific wave length range,

a housing attached to said light emitting element, said housing comprising a power supply for supplying electrical energy to the light emitting element, the housing having a component with dimensions resembling the dimensions of a segment of said tubular structure and said substantially cylindrical light emitting element, said two lamps of said set of lamps being adapted to be connected to one another to form a body having a substantially elliptical cross section with one of the focal points of the ellipse being within the one of said cylindrical light emitting elements and the other focal point of the ellipse within the other of said cylindrical light emitting elements.

According the present invention, the fixation means of the lamps serves a dual purpose viz. firstly the purpose of fixating the lamps relative to the tubular structure, such as the frame of the bicycle, to which the lamps are to be detachably mounted and secondly the purpose of cooperating with the other lamp in the set for connecting or linking the lamps together. The set of lamps includes a head lamp and a tail lamp to be used on a bicycle.

Since the two lamps of said set of lamps are adapted to be connected to one another to form a body having a substantially elliptical cross section with one of the focal points of the ellipse being within the one of said cylindrical light emitting elements and the other focal point of the ellipse within the other of said cylindrical light emitting elements, the lamps in the set can be very compactly stored when they are not used in fact they may be carried in a normal pocket.

The feature: the housing having a component with dimensions resembling the dimensions of a segment of said tubular structure and said substantially cylindrical light emitting element, which refers to a second entity, may in an embodiment of the invention be optional.

In a preferred embodiment according to the invention, said housing of one of the lamps in the set at least in part surrounds the substantially cylindrical light emitting element of the other lamp in the set, when the lamps are connected to each other, said housing further having a thickened free and a top recess, the top recess being shaped for receiving the thickened free end of the housing part of the other lamp in the set, the housing further comprising a locking protrusion extending over a part of said top recess, the locking protrusion having a surface being flush with the outer surface of the housing, and being shaped to cooperate with a corresponding notch at the free end of the resilient fixation means on the other lamp in the set, thereby facilitating snap locking engagement when the lamps are connected to one another.

According to a preferred embodiment of the invention, said housing of one of the lamps has an outer surface, which constitutes one half of a closed, continuous and convex surface, the other half of which is constituted by the outer surface of the housing of the other lamp in the set for establishing a closed, continuous and convex outer surface when the two lamps are connected to each other. Hereby is achieved a set of lamps with no sharp edges when they are connected to each other, whereby a possible damage to a pocket wherein the lamps may be stored when they are not used is precluded. Furthermore, they are smooth surface makes it more pleasant for a user to carry the set of lamps in the hand.

Preferably, the housing of each of the lamps is made of a plastics material—even more preferably from a slightly resilient plastic material. Hereby a light weight set of lamps is achieved.

In an embodiment the substantially cylindrical light emitting element of each of the lamps is equipped with electrically powered light generating means being constituted by for example a filament bulb, or a light diode or similar light generating source.

In an embodiment, the power source is constituted by one or more batteries, such as conventional batteries or alternatively rechargeable batteries or a photovoltaic solar panel. Preferably, each of the lamps is equipped with one, two or more Lithium batteries. Hereby is achieved the possibility of providing a very small lamp, which at the same time has a power supply by which it is possible to generate enough power that the light emitting elements thereby can fulfill the minimum legal requirements for the visibility of bicycle lights.

Each of the lamps may comprise a switchable electrical connector comprising a switch and electrical wires interconnecting power supply and said electrically powered light generating means through said switch. Said switch may in one embodiment be constituted by a manually operable on/off switch.

According to a preferred embodiment the switch on one of the lamps in the set is operated through contact with the housing of the other lamp in the set, for causing said power supply to stop supplying electrical power to said electrically powered light generating means. Hereby is achieved that the bicycle lamps are automatically turned off, when they are connected to each other. The switch on one of the lamps in the set is preferably adapted for causing said power supply to supply electrical power to said electrically powered light generating means, when the two lamps in the set is separated from each other.

According to a preferred embodiment, one of the lamps in the set is configured to be mounted on a substantially horizontal bar of a pair of handle bars of the bicycle, said one lamp being configured for emitting white or yellow light through the substantially cylindrical light emitting element and wherein the other one of the lamps in the set is configured to be mounted on a substantially vertical rod on which a saddle of the bicycle is mounted, said other lamp being configured for emitting red light through the substantially cylindrical light emitting element.

According to an embodiment of the set of lamps according to the present invention, the switch on one of the lamps in the set is a reed contact that cooperates with a magnetic element on the other lamp in the set. The reed contact being adapted for causing the supply of electrical power from the battery supply means to the electrically powered light generating means to be interrupted when the two lamps are connected together.

Further alternatively or additionally, the electrically powered light generating means may in accordance with specific requirements be adapted to generate light continuously or, alternatively, intermittently.

### BRIEF DESCRIPTION OF THE DRAWINGS

A further understanding of the nature and advantages of the present invention may be realized by reference to the remaining portions of the specification and the drawings.

In the following, preferred embodiments of the invention is explained in more detail with reference to the drawings, wherein

FIG. 1 shows a side view of an embodiment of a set of lamps according to the present invention is shown,

FIG. 2 shows a perspective view of an embodiment of the lamps and in a disassembled state,

FIG. 3 shows an embodiment of a head lamp is positioned in a snap fitting arresting position relative to a tubular structure,

FIG. 4 shows the head lamp and the tail lamp in a vertical sectional view,

FIG. 5 shows a side view of an embodiment of a set of lamps according to the present invention is shown, wherein one of the lamps is equipped with a loop, and

FIG. 6 shows how the two housings of the set of lamps may be snap fitted together.

### DETAILED DESCRIPTION

The present invention will now be described more fully hereinafter with reference to the accompanying drawings, in which exemplary embodiments of the invention are shown, The invention may, however, be embodied in different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout. Like elements will, thus, not be described in detail with respect to the description of each figure.

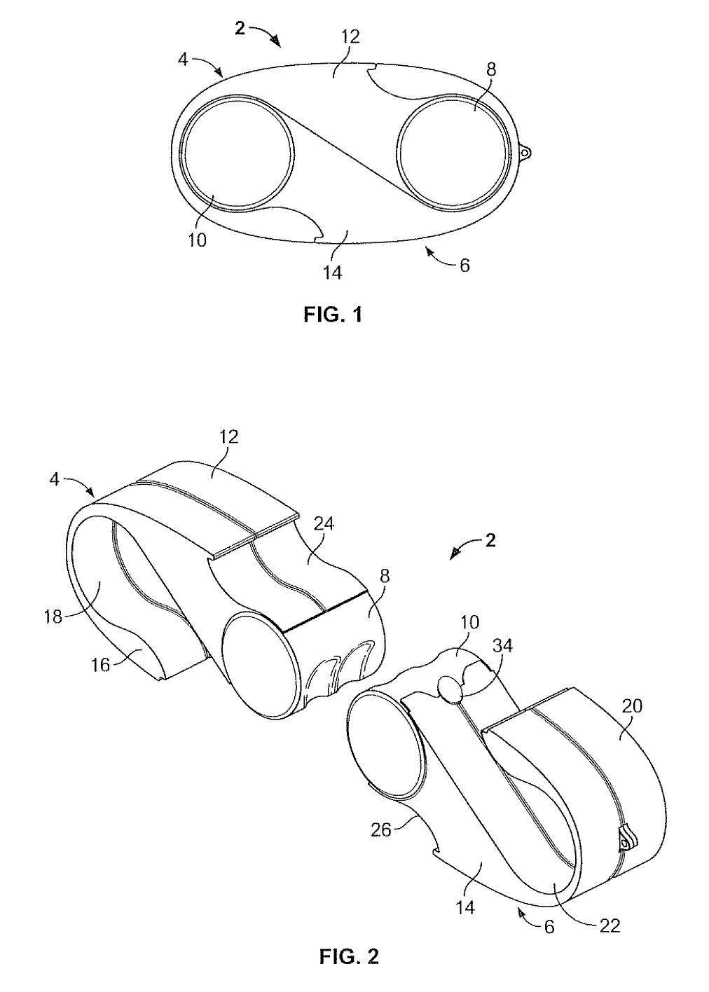

FIG. 1 shows a side view of an embodiment of a set of lamps according to the present invention is shown. The set of lamps is in its entirety designated the reference numeral 2 and comprises two lamps of basically identical configuration, however constituting a head lamp 4 and a tail lamp 6, respectively, for generating white or yellow light and red light, respectively. The head lamp 4 and the tail lamp 6 fit together in an assembled state or configuration shown in FIG. 1 in which the head lamp 4 and the tail lamp 6 together define a continuous outer surface of fairly small overall dimensions allowing that the head and rear lamps 4 and 6, respectively, may be stored together in e.g. a pocket of a jacket, a hand bag or suit case without occupying too much room and also without presenting outer sharp corners or edges which in some instances on the one hand might cause damage to the pocket or similar container in which the lamps are stored and on the other hand might obstruct the storing of the lamps.

The head lamp 4 comprises a substantially cylindrical light emitting element 8 for emitting visible light of a specific wave length or a specific wave length range. Similarly, the tail lamp 6 comprises a substantially cylindrical light emitting element 10 for emitting visible light of a specific wave length or a specific wave length range.

The illustrated head lamp 4 further comprises a housing 12 attached to said light emitting element 8, said housing comprising a power supply (not shown) for supplying electrical energy to the light emitting element 8. The housing 12 has a component with dimensions resembling the dimensions of a segment of a tubular structure to which the head lamp 4 may be attached during use. The dimension of said component also resembles the dimensions of a segment of the substantially cylindrical light emitting element 10 of the tail lamp 6. When the two lamps 4 and 6 are connected to one another they form a body having a substantially elliptical cross section with one of the focal points of the ellipse being within the one of said cylindrical light emitting element 8 and the other focal point of the ellipse within the other of said cylindrical light emitting element 10. The tail lamp 6 has also a housing 14 with similar dimensions and functions as the housing 12 of the head lamp 4.

FIG. 2 shows a perspective view of an embodiment of the lamps 4 and 6 in a disassembled state or configuration in which they are separated from one another, allowing that the lamps may be positioned at the front and the rear, respectively, of a bicycle in accordance with the prescribed regulations at periods of time during which the bicycle has to be provided with front or head lamp 4 and a rear or tail lamp 6

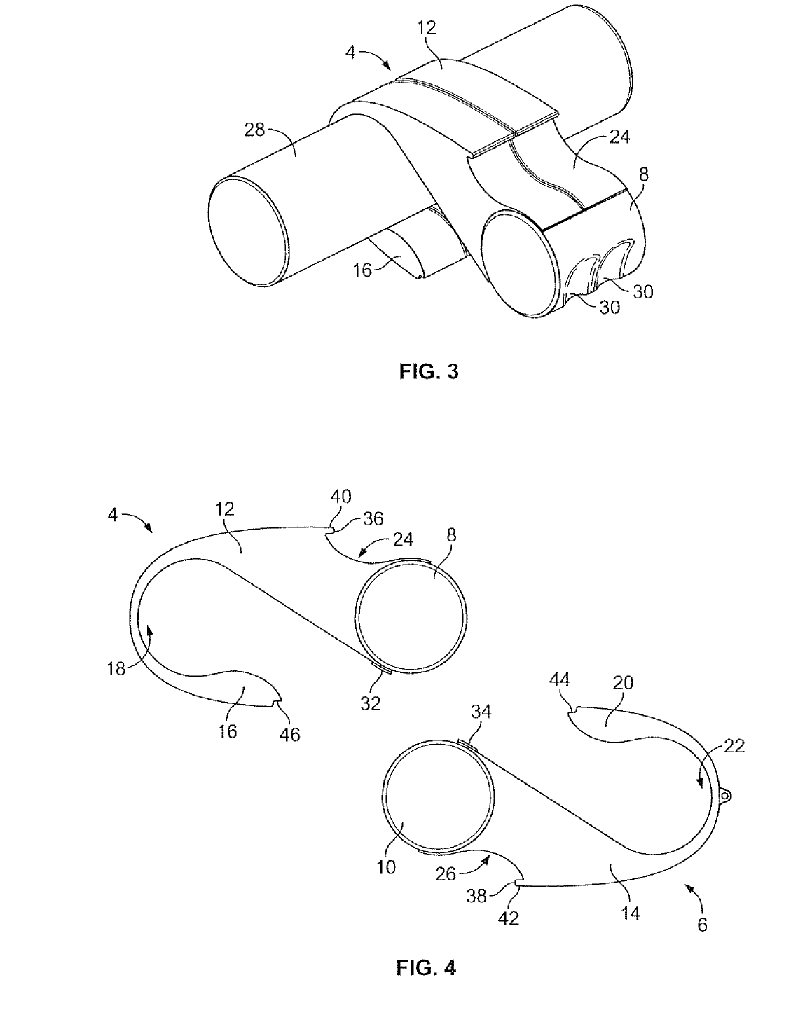

The housing 12 of the head lamp 4 is made of e.g. a plastics material, such as ABS, POM or equivalent strong and elastic material, and of a configuration similar to and fitting with the similar housing 14 of the tail lamp 6 in the assembled state or configuration as shown in FIG. 1. The housing 12 of the head lamp 4 and the housing 14 of the tail lamp 6 are provided with apertures of identical configurations for receiving the substantially cylindrical light emitting elements 8 and 10, respectively, for the transmission and radiation of white or yellow light and red light, respectively, from the head lamp 4 and the tail lamp 6, respectively. The substantially cylindrical light emitting elements 8 and 10 are of identical configurations, but have different light-transmitting properties and characteristics, as will be evident from the below description. The housing 12 of the head lamp 4 is provided with a flexible thickened end 16 defining a recess 18 within the housing 12 within which a tubular structure (not shown) of a bicycle may be received as illustrated in FIG. 3 or in which the element 10 of the tail lamp 6 may be received in the assembled state shown in FIG. 1.

Similarly, the housing 14 of the tail lamp 6 is provided with a flexible thickened end 20 defining a recess 22 similar to the recess 18 of the head lamp 4. The outer free end 16 of the housing 12 and similarly the outer free end 20 of the housing 14 are provided with thickened parts provided for establishing a snap fitting effect as the head or tail lamp 4 and 6, respectively, are positioned on a respective tubular structure or snap fitted together as shown in FIG. 1. For receiving the thickened free end 20 of the housing 14 of the tail lamp 6, the housing 12 of the head lamp 4 is provided with a shallow top recess 24 in which the thickened outer end 20 of the housing 14 is received as the head and tail lamps 4 and 6 are fit together as shown in fig. I

Similarly, the housing 14 of the tail lamp 6 is provided with a shallow recess 26 for receiving the thickened free end 16 of the housing 12 in the assembled state shown in FIG. 1.

FIG. 3 shows an embodiment of a head lamp 4 is positioned in a snap fitting arresting position relative to a tubular structure 28 which may constitute a horizontal bar of the handle bars of a bicycle. Similarly, the tubular structure 28 may constitute a rod on which the saddle of the bicycle is supported for receiving the tail lamp 6 in a position similar to the position shown in FIG. 3 in which the head lamp 4 is fixated and arrested relative to the tubular structure 28.

The head lamp 4 and the tail lamp 6 differ from one another except for the colour of the light which is radiated from the lamp in question, as the head lamp 4 is adapted to be positioned on a substantially horizontal bar, whereas the tail lamp 6 is adapted to be positioned on a substantially vertical bar. The patterns of the radiation of light from the two lamps, the head lamp 4 and the tail lamp 6, may have different configurations as the lamps have to radiate light which, in the intended position of the respective light, complies with the prescribed regulations, which in some countries of the world prescribe that the lamp is to be visible up to a distance of 300 m from the lamp, being the head lamp or the tail lamp, within an angle of 115 degrees to both sides from the longitudinal axis of the lamp in question in the horizontal plane, whereas the lamp in question, being the head lamp or the tail lamp, should radiate light within a fairly small angle of 15 degrees above the horizontal plan and 15 degrees below the horizontal plane relative to the intended position of use of the lamp in question.

For radiating and beaming light from the elements 8 and 10 of the head lamp 4 and tail lamp 6, respectively, the elements 8 and 10 are provided with facial parts of light-beaming and light-scattering structures 30.

For complying with the above requirement of radiating light which is visible within an angle of 115 degrees to both sides relative to the longitudinal axis of the tail lamp 6 in the intended application of use of the tail lamp 6, in which application the tail lamp is turned 90 degrees relative to the intended position of the head lamp 4, light-beaming and light-scattering structures 30 of the element 10 of the tail is turned 90 degrees relative to the light-beaming and light-scattering structures 30 of the head lamp 4.

The generation of white or yellow light and red light by the head lamp 4 and the tail lamp 6, respectively, may be realized by means of selecting a white or yellow and a red light-generating source, such as a white or yellow and a red lamp, respectively. Alternatively and preferably, the white or yellow light radiated by the head lamp 4 is generated by means of a conventional filament light bulb diode transmitting white or yellow light, whereas the red light transmitted by the tail lamp 6 is generated by means of a similar filament light bulb generating white or yellow light which is transmitted through a coloured filtering element which may be constituted by the element 10 of the tail lamp 6. Different light sources, such as light diodes generating white or yellow light and red light, respectively, may alternatively be used.

FIG. 4 shows the head lamp 4 and the tail lamp 6 in a vertical sectional view. The contour of the housings 12 and 14 of the head and tail lamps 4 and 6, respectively, are shown as well as the contours of the substantially cylindrical light-transparent and light-transmitting elements 8 and 10 of the head and tail lamp 4 and 6, respectively. In FIG. 4, two micro switches 32 and 34 are also shown which serve the purpose of turning the tail lamp 4 on or off. The micro switches 32 and 34 are on/off switches operated as the head and tail lamps 4 and 6 are assembled (like in the state or configuration shown in FIG. 1) causing them to be turned off. Alternative positions of the micro switches are of course also contemplated.

Each of the housings 12, 14 further comprises a locking protrusion 36, 38, respectively. The locking protrusion 36 of the housing 12 extends over a part of the top recess 24, and the locking protrusion 38 extends over a part of the recess 26. Both locking protrusions 36, 38 have an outer surface 40, 42, respectively, which is flush with the outer surface of the respective housing 12, 14. The locking protrusion 36 on the housing 12 of the head lamp 4 is shaped to cooperate with a corresponding notch 44 at the free end 20 of the housing 14 of the tail lamp 6. Similarly, the locking protrusion 38 on the housing 14 of the tail lamp 6 is shaped to cooperate with a corresponding notch 46 at the free end 16 of the housing 12 of the head lamp 4, thereby facilitating snap locking engagement when the lamps 4, 6 are connected to one another.

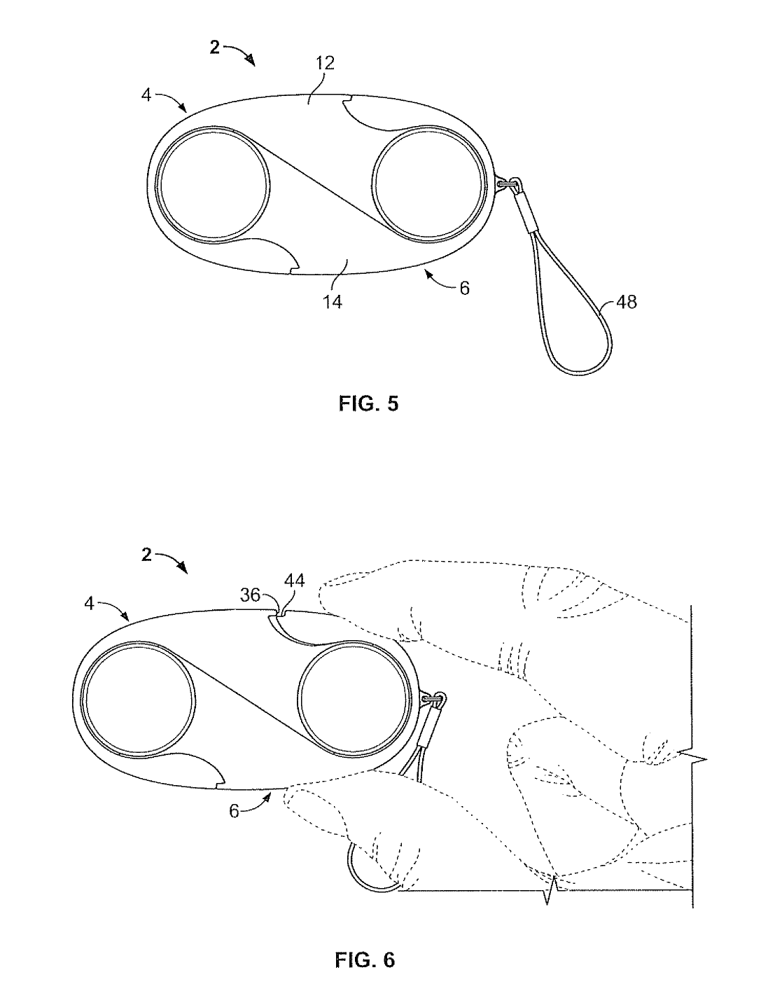

FIG. 5 shows the set of bicycle lamps 2 in the configuration, wherein they are interconnected to each other. One of the housings 12, 14 in the set 2 of lamps 4, 6 may be equipped with a loop 48. In the illustrated example the housing 14 is equipped with a loop 48 The loop 48 may in an embodiment be made from an elastic material or at least have an elastic portion This loop 48 may be used to attach the set 2 of lamps 4, 6 to for example a peg or other suitable place of storage.

FIG. 6 illustrates how the housings 12 and 14 of the head lamp 4 and tail lamp 6 can be brought into an interlocking connection with each other, After fitting the two housings 12, 14 together so that the substantially cylindrical light emitting element 8 is positioned within the recess 22 of the housing 14 of the tail lamp 6, and the substantially cylindrical light emitting element 10 is positioned within the recess 18 of the housing 12 of the head lamp 4, then the user can, with his/her finger squeeze on the outer surface of the thickened free end 20 of the housing 14 of the tail lamp 6

Hereby the locking protrusion 36 of the housing 12 of the head lamp is brought into locking engagement with the notch 44 of the thickened free end 20 of the housing 14 of the tail lamp 6, thereby bringing the lamps 4, 6 into interlocking connection with each other, when they are connected to each other.

In the illustrated embodiments is has been found advantageous to two CR2032 batteries with 3V with about 220 mAh, which gives 0 66 Wh pr. battery and thereby 1 32 Wh for the two.

If the two batteries are connected in series it would give 6V. 1 32 Wh divided by 6V gives 220 mAh However, only 3V is needed in order to achieve sufficient voltage for the light emitting elements, Hence, in a preferred embodiment of the invention, the batteries are connected in parallel. This will give 3V in total, and thereby 1 32Wh/3V32 440 mAh Therefore the parallel connected batteries will provide the sufficient Power that is needed, but double the lifetime of the batteries

### LIST OF REFERENCE NUMBERS

In the following is given a list of reference numbers that are used in the detailed description of the invention.
2 set of lamps,
4, 6 head lamp, tail lamp,
8, 10 substantially cylindrical light emitting elements,
12, 14 housing of the lamps,
16, 20 thickened free end of the housings of the lamps,
18, 22 inner recess of the housings,
24, 26 top recess of housing,
28 tubular structure,
30 light-beaming and light-scattering structures,
32, 34 micro switches,
36, 38 locking protrusion,
40, 42 outer surface of locking protrusion,
44, 46 notch at free end of housing, and
48 loop.

1-10. (canceled)

11. A set of bicycle lamps for detachable mounting on a tubular structure of a bicycle, said set of lamps comprising a front lamp and a rear lamp, each of said lamps comprising:
a substantially cylindrical light emitting element for emitting visible light of a specific wave length or a specific wave length range; and
a housing attached to said light emitting element, said housing comprising a power supply for supplying electrical energy to the light emitting element, the housing having a component with dimensions resembling the dimensions of a segment of said tubular structure and said substantially cylindrical light emitting element, said two lamps of said set of lamps being adapted to be connected to one another to form a body having a substantially elliptical cross section with one of the focal points of the ellipse being within the one of said cylindrical light emitting elements and the other focal point of the ellipse within the other of said cylindrical light emitting elements.

12. A set of bicycle lamps according to claim 11, wherein said housing of one of the lamps in the set at least in part surrounds the substantially cylindrical light emitting element of the other lamp in the set, when the lamps are connected to each other, the housing further having a thickened free end and a top recess shaped for receiving the thickened free end of the housing part of the other lamp in the set, the housing further comprising a locking protrusion extending over a part of said top recess, the locking protrusion having a surface being flush with the outer surface of the housing, and being shaped to cooperate with a corresponding notch at the free end of a resilient fixation device on the other lamp in the set, thereby facilitating snap locking engagement when the lamps are connected to one another.

13. A set of bicycle lamps according to claim 11, wherein said housing of one of the lamps has an outer surface, which constitutes one half of a closed, continuous and convex surface, the other half of which is constituted by the outer surface of the housing of the other lamp in the set for establishing said closed, continuous and convex outer surface when the two lamps are connected to each other.

14. A set of bicycle lamps according to claim 11, wherein said housing of each of the lamps is made of a plastics material.

15. A set of bicycle lamps according to claim 11, said substantially cylindrical light emitting element is equipped with an electrically powered light generating device being constituted by a filament bulb, a light diode or similar light generating source.

16. A set of bicycle lamps according to claim 11, wherein the power source is constituted by one or more batteries, such as conventional batteries or alternatively rechargeable batteries or a photovoltaic solar panel.

17. A set of bicycle lamps according to claim 15, wherein each of the lamps comprises a switchable electrical connector comprising a switch and electrical wires interconnecting power supply and said electrically powered light generating device through said switch.

18. A set of bicycle lamps according to claim 16, wherein each of the lamps comprises a switchable electrical connector comprising a switch and electrical wires interconnecting power supply and said electrically powered light generating device through said switch.

19. A set of bicycle lamps according to claim 17, said switch being constituted by a manually operable on/off switch.

20. A set of bicycle lamps according to claim 17, wherein the switch on one of the lamps in the set is operated through contact with the housing of the other lamp in the set, for causing said power supply to stop supplying electrical power to said electrically powered light generating device.

21. A set of bicycle lamps according to claim 11, wherein one of the lamps in the set is configured to be mounted on a substantially horizontal bar of a pair of handle bars of the bicycle, said one lamp being configured for emitting white or yellow light through the substantially cylindrical light emitting element and wherein the other one of the lamps in the set is configured to be mounted on a substantially vertical rod on which a saddle of the bicycle is mounted, said other lamp being configured for emitting red light through the substantially cylindrical light emitting element.
